(19) United States
(12) Patent Application Publication
(10) Pub. No.: US 2019/0129914 A1
(43) Pub. Date: May 2, 2019

(54) IMPLEMENTATION METHOD OF A NON-RADIX-2-POINT MULTI DATA MODE FFT AND DEVICE THEREOF

(71) Applicant: AMLOGIC (SHANGHAI) CO., LTD., Shanghai (CN)

(72) Inventors: Yang Zou, Shanghai (CN); Hui Rong, Shanghai (CN); Qiaoming Xu, Shanghai (CN)

(73) Assignee: AMLOGIC (SHANGHAI) CO., LTD., Shanghai (CN)

(21) Appl. No.: 15/558,397

(22) PCT Filed: Apr. 18, 2017
(86) PCT No.: PCT/CN2017/080953

§ 371 Date: Sep. 14, 2017

(30) Foreign Application Priority Data
Jul. 18, 2016 (CN) 201610566194.0

(51) Int. Cl. G06F 17/14

(52) U.S. Cl. CPC G06F 17/142

(57) ABSTRACT

The invention relates to an implementation method of a non-radix-2-point multi data mode FFT. The implementation method comprising: using the mixed radix algorithm and prime factor decomposition algorithm to decompose the original FFT operation as the cascaded FFT operations of the multi-level programmable WFTA operations. The first-level programmable WFTA unit implements 3 point, 3 point, 5 point, and 3 point FFT operations. The second-level programmable WFTA unit implements 4 point, 5 point, 5 point, and 5 point FFT operations. The third-level programmable WFTA unit implements 9 point, 8 point, 5 point, and 9 point FFT operations. The fourth-level programmable WFTA unit implements 5 point, 5 point, 5 point, and 5 point FFT operations. The fifth-level programmable WFTA unit implements 7 point, 7 point, 7 point, and 7 point FFT operations. Each level of the programmable WFTA units is an FFT operation stage.

### CROSS-REFERENCE TO RELATED APPLICATIONS

The present application claims priority to and the benefit of Chinese Patent Application No. CN 201610566194.0, filed on Jul. 18, 2016, the entire content of which is incorporated herein by reference.

### BACKGROUND OF THE INVENTION

### 1. Field of the Invention

The invention relates to a data processing for fast Fourier transform, more specifically, to the implementation method of a non-radix-2-point multi data mode FFT and device thereof.

### 2. Description of the Related Art

At present, the method of FFT (Fast Fourier Transform) is to divide the 3780 point FFT into three layers. The top layer decomposes 3780 point FFT by the mixed radix method. The middle layer decomposes 63 point FFT and 60 point FFT with the prime factor algorithm. The bottom layer accomplishes 7 point, 9 point, 3 point, 4 point, and 5 point FFT operation with Winograd Fourier Transform Algorithm (WFTA) algorithm. However, this method can only address the operation requirement of a fixed non-radix-2-point (3780 point), and the points which the FFT needs to be operated cannot be flexibly configured according to the requirement.

The above mentioned method cannot meet the requirements of the various operation points of FFT, so that the operation efficiency of FFT is low.

### SUMMARY OF THE INVENTION

For the deficiencies of the prior art, the present invention provides a implementation method of a non-radix-2-point multi data mode FFT and device thereof, and they can realize various non-radix-2-point multi mode FFT operations covering 3780 point, 422 point, 4375 point, and 4725 point.

The invention utilizes the following technical scheme.

An implementation method of a non-radix-2-point multi-data mode FFT, which is applied to a DTMB demodulation algorithm for 3780 point data, 4200 point data, 4375 point data, and 4725 point data, comprising the first-level and second-level decomposition for the DTMB demodulation algorithm for 3780 point data, 4200 point data, 4375 point data, and 4725 point data. The second-level decomposition includes a first stage and a second stage. The first stage is carried out before or after the second stage, and the internal orders of the first stage and the second stage are not limited and can be adjusted according to the actual situation, and the first-level decomposition includes: by using mixed radix algorithm, decomposing the 3780 point data into 108×35, decomposing the 4200 point data into 120×35, decomposing the 4375 point data into 125×35 and the 4725 point data into 135×35.

The first stage of the second-level decomposition is: by using mixed radix algorithm, decomposing the 108 point into 3×4×9, decomposing the 120 point into 3×5×8, decomposing the 125 point into 5×5×5, decomposing the 135 point into 3×5×9, wherein, by using a first-level programmable WFTA unit, the FFT operations for the 3 point in the 3780 point data, the 3 point in the 4200 point data, the 5 point in the 4375 point data and the 3 point in 4725 point data are implemented.

By using a second-level programmable WFTA unit, the FFT operations for the 4 point in the 3780 point data, the 5 point in 4200 point data, the 5 point in 4375 point data and the 5 point in 4725 point data are implemented.

By using a third-level programmable WFTA unit, the FFT operations for the 9 point in 3780 point data, the 8 point in 4200 point data, the 5 point in 4375 point data and the 9 point in 4725 point data are implemented.

The second stage of the second-level decomposition is: decomposing 35 into 5×7 by the prime factor decomposing algorithm, wherein, by using the fourth-level programmable WFTA unit, the FFT operations for the 5 point in 3780 point data, the 5 point in 4200 point data, the 5 point in 4375 point data and the 5 point in 4725 point data are implemented, by using the fifth-level programmable WFTA unit, the FFT operations for the 7 point in 3780 point data, 7 point in 4200 point data, 7 point in 4375 point data and 7 point in 4725 point data are implemented.

Preferably, the implementation method further comprises, in the first stage of the second-level decomposition, among the corresponding three programmable WFTA units, namely the first-level, second-level and third-level programmable WFTA units, the operations between two adjacent programmable WFTA units use the SRAM cache of Ping Pong structure.

In the two programmable WFTA units corresponding to the boundary of the first-level decomposition, namely the third-level and fourth-level programmable WFTA units, the operations between two adjacent programmable WFTA units use the SRAM cache of master-slave structure. The slave SRAM works only when the master SRAM cache works, meanwhile, the slave SRAM cache is omitted in the absence of consecutive FFT operation requirements, so that the resources will be saved.

In the two programmable WFTA units corresponding to the second stage of the second-level decomposition, namely the fourth-level and fifth-level programmable WFTA units, the operations between two adjacent programmable WFTA units use the SRAM cache of Ping Pong structure.

The SRAM cache of Ping Pong structure switches a plurality of times in a FFT operation. The master-slave SRAM cache does not switch in a FFT operation, and there is only one switch between consecutive FFT operations.

Preferably, the implementation method further comprises: the conjugation operation is carried out before and/or after the first-level programmable WFTA unit and/or the second-level programmable WFTA unit and/or the third-level programmable WFTA unit and/or the fourth-level programmable WFTA unit and/or the fifth-level programmable WFTA units implement the FFT operation.

Preferably, in the implementation method, the FFT operation is carried out according to the data streams of the first-level, the second-level, the third-level, the fourth-level and the fifth-level programmable WFTA units, and the FFT operation is carried out according to the reverse data streams of the fifth-level, the fourth-level, the third-level, the second-level and the first-level programmable WFTA units, wherein, the inverse fast Fourier transform (IFFT) operation is implemented by conjugating the data before and after the FFT operation.

A non-radix-2-point multi-data mode FFT implementation system, which is applied to a DTMB demodulation algorithm for 3780 point data, 4200 point data, 4375 point data, and 4725 point data, comprising a multi mode FFT module. The multi mode FFT module includes: The 3780 point data, the 4200 point data, the 4375 point data, and the 4725 point data are performed FFT operations by the successive programmable WFTA units, each level of the programmable WFTA units is an FFT operation stage; and the first-level decomposition use the mixed radix algorithm, a first phase rotation unit is connected between two adjacent programmable WFTA units, the first phase rotation unit is connected to a first storage unit, the first storage unit is also connected to the programmable WFTA unit of the next FFT operation stage, the first storage unit mixedly and successively stores the data of the first phase rotation unit by using the master-slave structure; and the first stage of the second-level decomposition uses the mixed radix algorithm, a second phase rotation unit is connected between two adjacent programmable WFTA units in the first stage of the second-level decomposition, the second phase rotation unit is connected to the second storage unit, the second phase rotation unit is also connected to the programmable WFTA unit of the next FFT operation stage. The second storage unit fixedly and successively stores the data of the second phase rotation unit by using the Ping Pong structure, and the second stage of the second-level decomposition uses the prime factor decomposition algorithm, a phase rotation unit is not required between two adjacent programmable WFTA units in the second stage of the second-level decomposition, and a third storage unit is directly connected to the programmable WFTA unit of the next FFT operation phase. The third storage unit fixedly and successively stores the data by using the Ping Pong structure.

Preferably, the implementation system further comprises a conjugate unit, including a first conjugate unit and a second conjugate unit; the first conjugate unit is connected to the first one of the successive programmable WFTA units and conjugates the input data of the first programmable WFTA unit; the second conjugate unit is connected to the last one of the successive programmable WFTA units and conjugates the output data of the last programmable WFTA unit.

It is configurable to let the first conjugate unit and the second conjugate unit operate, to implement the IFFT operation function.

Preferably, the implementation system further comprises a multi mode IFFT module, the multi mode IFFT module is connected to the multi mode FFT module, and the multi mode FFT module is cascaded to the multi mode IFFT module, to implement FFT operation and IFFT iteration operation.

The beneficial effects of the present invention are as follows.

The present invention can implement non-radix-2-point multi data mode FFT or IFFT operation, receive new FFT input without waiting for the accomplishment of output of current FFT, and meanwhile implement non-radix-2-point multi data mode successive FFT or IFFT operation in the DTMB demodulation operation, that is, implement multiple FFT and IFFT iterative operations in the DTMB demodulation operation for the four kinds of data mode comprising 3780 point data, 4200 point data, 4375 point data and 4725 point data.

### BRIEF DESCRIPTIONS OF THE DRAWINGS

The accompanying drawings, together with the specification, illustrate exemplary embodiments of the present disclosure, and, together with the description, serve to explain the principles of the present invention.

FIG. 1 is a schematic diagram of the programmable WFTA unit of the present invention;

FIG. 2 is an operation schematic diagram of the multi mode FFT module of the present invention;

FIG. 3 is a multi mode FFT module of the present invention based on the 3780 point, 4200 point, 4375 point and 4725 point FFT operations;

FIG. 4 is a multi mode IFFT module of the present invention based on the 3780 point, 4200 point, 4375 point and 4725 point FFT operations;

FIG. 5 is a schematic diagram of implementing the iterative operation between a multi mode FFT module and a multi mode IFFT module of the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one

Hereinafter, certain exemplary embodiments according to the present disclosure will be described with reference to the accompanying drawings.

4200, 4375, 4725 and other non-radix-2-point FFT computing requirements are added into the new DTMB demodulation algorithm research. The mixed implementation of 3780, 4200, 4375, 4725 and other non-radix-2-point FFT will seriously increase the complexity and cost. The invention aims to use a multi mode FFT module to implement multi mode FFT operation modules compatible with non-radix-2-point such as 3780, 422, 4375, and 4725.

In the embodiment, the programmable WFTA unit is used to implement the FFT and WFTA equations: X=O*D*I*x; and the external control module makes the WFTA FFT unit operate in multi mode FFT module (7 point, 9 point, 3 point, 5 point, and 4 point).

The following technical solution can be adopted in the 3780 point, 4200 point, 4375 point and 4725 point FFT operations in the DTMB demodulation algorithm:

first, 3780 point, 4200 point, 4375 point, and 4725 point are decomposed separately into 108×35, 120×35, 125×35 and 135×35 by mixed radix algorithm;

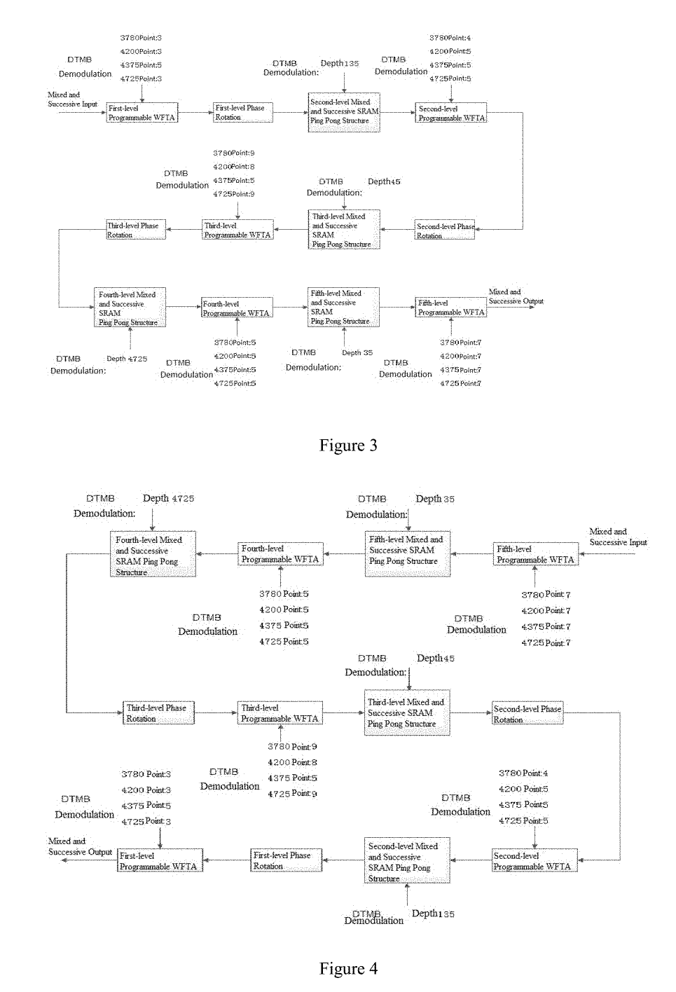

then, 108 point, 120 point, 125 point, and 135 point are decomposed separately into 3×4×9, 3×5×8, 5×5×5 and 3×5×9 by using mixed radix algorithm, wherein, 9 point, 3 point, 5 point, and 4 point are separately realized through the programmable WFTA unit. The above-mentioned programmable WFTA unit includes the first-level programmable WFTA unit, second-level programmable WFTA unit and third-level programmable WFTA unit. As shown in FIG. 3, the first-level programmable WFTA unit implements the FFT operations on 3 point of 108 point, 3 point of 120 point, 5 point of 125 point, and 3 point of 135 point. The second-level programmable WFTA unit implements the FFT operations on 4 point of 108 point, 5 point of 120 point, 5 point of 125 point and 5 point of 135 point. The third-level programmable WFTA unit implements the FFT operations on 9 point of 108 point, 8 point of 120 point, 5 point of 125 point and 9 point of 135 point.

Afterwards, 35 is decomposed into 5×7 by using prime factor decomposition algorithm, wherein 5, 7 are realized through the programmable WFTA units, which are the fourth and fifth-level programmable WFTA units in the non-radix-2-point multi mode FFT. As shown in FIG. 3, the fourth-level programmable WFTA unit implements the FFT operations on 5 point of 35 point in the 3780 point, 4200 point, 4375 point and 4725 point. The fifth-level programmable WFTA unit implements the FFT operations on 7 point of 35 point in the 3780 point, 4200 point, 4375 point and 4725 point.

As shown in FIG. 1, B Coef, G Coef and C Coef are the coefficients of the three matrices in the WFTA algorithm respectively. In the embodiment, it is calculated through the WFTA coefficient list of 3, 4, 5, 7, 9 data mode; D11˜D1n are the registers which compose two sets of shift register, and the shift register shift the input data to form a pipeline input; AC1˜ACn are the accumulators which operate on the input data under the control of the coefficient matrix; MUX is the multiplexer, which selects the output of the corresponding accumulator as the output of the first operation stage or the third operation stage. For example, if there are only 0, 1 and −1 in the C and B matrix elements of 5 point WFTA standard expression, the matrix multiplication of the first operation stage and third operation stage is actually an accumulation of input data. When the first element of each row in the matrix is 1, the value of the corresponding accumulator is equal to the corresponding input data, when the first element of each row in the matrix is 0, the value of the accumulator is set to 0; when the other elements of each row in the matrix are 1, the accumulator performs the addition operation, that is, the value of the accumulator is the original value plus the new input data. When the other elements of each row in the matrix are −1, the accumulator performs the subtraction operation, that is, the value of the accumulator is the original value minus the new input data; when the other elements of each row in the matrix are 0, the accumulator performs the hold function, that is, the value of the latter state is equal to the value of previous state. 7 point WFTA structure, 9 point WFTA structure and 3 point WFTA structure, that is the input data control mode, are basically similar to 5 point. The 4 point WFTA structure is similar to the second operation stage of 5 point WFTA structure. Thus they are not described herewith.

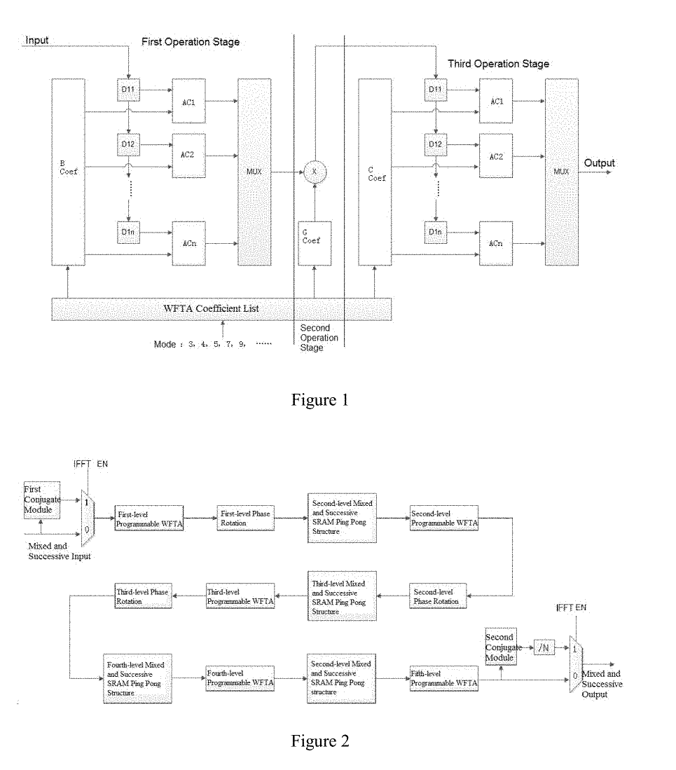

As shown in FIGS. 2 and 3, Ping Pong or master-slave structure of the SRAM cache data is used in the above-mentioned five level programmable WFTA unit, which allows the module to perform successive FFT operations and improves the efficiency of the FFT module. Further, the conjugate modules can be added before and after the above-mentioned five level programmable WFTA FFT units, in which the conjugate modules are the first conjugate module and the second conjugate module respectively. The first conjugate module and the second conjugate module perform data conjugation selection to implement FFT and IFFT function shifts. Therefore, a complete non-radix-2-point multi mode FFT device A has been achieved.

For example, a set of data with the length of 3780 point is shown in FIG. 2. The operations of the other point are similar to 3780 point. 3780 point data is entered into the first conjugate module in the synchronization of the clock. The IFFT enable signal determines whether or not the conjugation calculation is performed. The 3780 point data output by the conjugate module is decomposed into the 1260 sets of 3 point data by the first stage of the FFT first-level decomposition and the FFT second-level decomposition. The data is driven by the FFT enable signal and enters the first-level programmable WFTA operation unit (the first-level programmable WFTA) to implement 3 point FFT operation. After the operation, the second phase rotation unit (the first phase rotation) performs the phase rotation of the data, and then the data is stored in the corresponding address of the second storage unit (the second-level mixed and successive SRAM (static random access memory) Ping Pong structure) to achieve the original address operation. According to the above-mentioned method, the operation is implemented until the fifth-level programmable WFTA, and the output data enters into the second conjugate unit. The IFFT enable signal determines whether or not the conjugation calculation is performed. The second conjugate unit outputs the result and completes the 3780 point FFT or IFFT operation. It should be noted that the second phase rotation unit in the embodiment may include a first-level phase rotation, second-level phase rotation and third-level phase rotation. The second storage unit consists of the second-level mixed and successive SRAM Ping Pong structure, and third-level mixed and successive SRAM Ping Pong structure.

The second stage of the second-level decomposition uses the prime factor decomposition algorithm, a phase rotation unit is not required between two adjacent programmable WFTA units in the second stage of the second-level decomposition, and the third storage unit (the fourth-level mixed and successive SRAM Ping Pong structure and fifth-level mixed and successive SRAM Ping Pong structure) is directly connected to the programmable WFTA unit of the next FFT operation stage. The third storage unit mixedly and successively stores the data by using the Ping Pong structure.

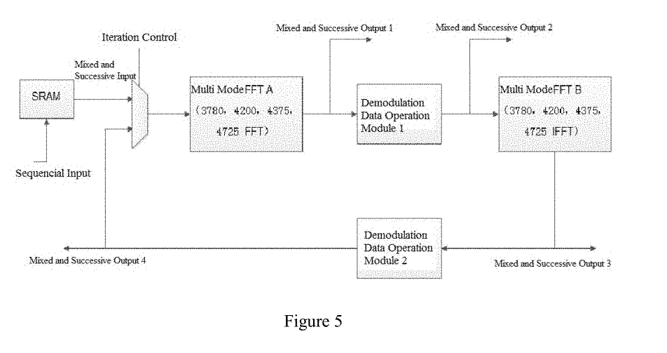

As shown in FIG. 4, the data stream of the five level programmable WFTA units of the multi mode FFT module is inverted, so as to realize a multi mode IFFT or FFT operation that can be directly connected with the output of the multi mode FFT or IFFT operation module.

In order to achieve the mixed and successive SRAM (storage unit) of the Ping Pong structure and the master-slave structure, the 3780 data, for example, will be divided into 35 sets of 108 point data, they will be stored in the two-level Ping Pong structure mixed and successive SRAM set by set. Two SRAM of Ping Pong structure will be alternately in the state of writing and reading. The third-level mixed and successive SRAM and fifth-level mixed and successive SRAM will be at operation mode of the two-level mixed and successive SRAM similarly. The four-level mixed and successive SRAM is located at the edge of the FFT first-level decomposition. A frame with 3780 point data is all stored in the fourth-level mixed and successive SRAM and then all be read out. When the multi-frame 3780 point data is input, two SRAMs in the fourth-level master-slave structure mixed and successive SRAM will alternately accomplish the writing in and reading of 3780 point data, thus the real-time processing of the 3780 point data has been realized. If the next frame data is always input after the current frame data is completely read out from the fourth-level mixed and successive SRAM. In this way, only one of the two SRAMs in the fourth-level master-slave structure mixed and successive SRAM independently writes and reads 3780 point data, which saves the usage of SRAM.

As shown in FIG. 5, the cascading of the multi mode FFT modules can implement the successive FFT and IFFT operations and multiple FFT and IFFT iteration operations.

In conclusion, the present invention can implement non-radix-2-point multi data mode FFT or IFFT operation, receive new FFT input without waiting for the accomplishment of output of current FFT, and meanwhile implement non-radix-2-point multi data mode successive FFT or IFFT operation in the DTMB demodulation operation, that is, implement multiple FFT and IFFT iterative operations in the DTMB demodulation operation for the four kinds of data mode comprising 3780 point data, 4200 point data, 4375 point data and 4725 point data.

The foregoing is only the preferred embodiments of the invention, not thus limiting embodiments and scope of the invention, those skilled in the art should be able to realize that the schemes obtained from the content of specification and figures of the invention are within the scope of the invention.

What is claimed is:

1. The implementation method of a non-radix-2-point multi mode FFT, wherein the method is applied to a DTMB demodulation algorithm for 3780 point data, 4200 point data, 4375 point data, and 4725 point data, comprising the first-level and second-level decomposition for 3780 point data, 4200 point data, 4375 point data, and 4725 point data, wherein
the first-level decomposition includes
By using a mixed radix algorithm, decomposing 3780 point data into 108×35, decomposing 4200 point data into 120×35, decomposing 4375 point data into 125×35 and 4725 point data into 135×35;
the second-level decomposition includes a first stage and a second stage, the first stage is implemented before or after the second stage, the first stage decomposes 108 into 3×4×9, decomposes 120 into 3×5×8, decomposes 125 into 5×5×5, and decomposes 135 into 3×5×9 by using mixed radix algorithm, comprising:
by using a first-level programmable WFTA unit, the FFT operations for 3 point in 3780 point data, 3 point in 4200 point data, 5 point in 4375 point data and 3 point in the 4725 point data are implemented;
by using a second-level programmable WFTA unit, the FFT operations for 4 point in 3780 point data, 5 point in 4200 point data, 5 point in 4375 point data, and 5 point in 4725 point data are implemented;
by using a third-level programmable WFTA unit, the FFT operations for 9 point in the 3780 point data, 8 point in 4200 point data, 5 point in 4375 point data, and 9 point in 4725 point data are implemented,
the second stage decomposes 35 into 5×7 by using prime factor decomposing algorithm, including:
by using the fourth-level programmable WFTA unit, the FFT operations for 5 point in 3780 point data, 5 point in 4200 point data, 5 point in 4375 point data and 5 point in 4725 point data are implemented,
by using the fifth-level programmable WFTA unit, the FFT operations for 7 point in 3780 point data, 7 point in 4200 point data, 7 point in 4375 point data, and 7 point in 4725 point data are implemented.

2. The method according to claim 1, further comprising
in the first-level programmable WFTA unit, second-level programmable WFTA unit and third-level programmable WFTA unit, the operations between two adjacent programmable WFTA units use the SRAM cache of Ping Pong structure; or
the operations between the third-level programmable WFTA unit and the fourth-level programmable WFTA unit use the SRAM cache of master-slave structure, wherein the slave SRAM operates when the master SRAM operates; or
the operations between the fourth-level programmable WFTA unit and fifth-level programmable WFTA unit use the SRAM cache of Ping Pong structure.

3. The method according to claim 1, further comprising:
the conjugation operation is carried out before and/or after the first-level programmable WFTA unit, the second-level programmable WFTA unit, the third-level programmable WFTA unit, the fourth-level programmable WFTA unit and/or the fifth-level programmable WFTA unit implement the FFT operation.

4. The method according to claim 3, wherein
the FFT operation is carried out according to the data streams of the first-level, the second-level, the third-level, the fourth-level and the fifth-level programmable WFTA units, and
the FFT operation is carried out according to the reverse data streams of the fifth-level, the fourth-level, the third-level, the second-level and the first-level programmable WFTA units, wherein
the IFFT operation is performed by conjugating the data before and after the FFT operation.

5. A non-radix-2-point multi-data mode FFT implementation system, wherein the system is applied to a DTMB demodulation algorithm for 3780 point data, 4200 point data, 4375 point data, and 4725 point data, including a multi mode FFT module, the multi mode FFT module comprises:
3780 point data, 4200 point data, 4375 point data, and 4725 point data are performed FFT operations by the successive programmable WFTA units, each level of the programmable WFTA units is an FFT operation stage, the FFT operation stage includes a first-level and a second-level decomposition, the first-level decomposition uses the mixed radix algorithm and the second-level decomposition includes a first stage and a second stage, in which the first stage uses the mixed radix algorithm and the second stage uses the prime factor decomposition algorithm; and
in the first-level decomposition, a first phase rotation unit is connected between two adjacent programmable WFTA units, the first phase rotation unit is connected to a first storage unit, the first storage unit is also connected to the programmable WFTA unit of the next FFT operation stage, the first storage unit mixedly and successively stores the data of the first phase rotation unit by using the master-slave structure; and
the first stage of the second-level decomposition, a second phase rotation unit is connected between two adjacent programmable WFTA units, the second phase rotation unit is connected to the second storage unit, the second storage unit is also connected to the programmable WFTA unit of the next FFT operation stage, the second storage unit fixedly and successively stores the data of the second phase rotation unit by using the Ping Pong structure, and
in the second stage of the second-level decomposition, a third storage unit is connected to two adjacent programmable WFTA units, the third storage unit fixedly and successively stores the data by using the Ping Pong structure.

6. The system according to claim 5, further comprising:
the conjugate unit, including a first conjugate unit and a second conjugate unit;
the first conjugate unit is connected to the first one of the successive programmable WFTA units and conjugates the input data of the first programmable WFTA unit;
the second conjugate unit is connected to the last one of the successive programmable WFTA units and conjugates the output data of the last programmable WFTA unit.

7. The system according to claim 6, further comprising: a multi mode IFFT module which is connected to the multi mode FFT module, and the multi mode FFT module is cascaded to the multi mode IFFT module to implement FFT operation and IFFT iteration operation.
